(19) United States
(12) Patent Application Publication
(10) Pub. No.: US 2026/0030551 A1
(43) Pub. Date: Jan. 29, 2026

(54) SYSTEMS AND METHODS FOR LOW LATENCY STATE DETECTION USING GRADIENT BOOSTING

(71) Applicant: The Regents of the University of California, Oakland, CA (US)

(72) Inventors: Kyle Gaulton, La Jolla, CA (US); Hannah Carter, La Jolla, CA (US); Carolyn McGrail, La Jolla, CA (US); Timothy J. Sears, La Jolla, CA (US)

(73) Assignee: The Regents of the University of California, Oakland, CA (US)

(21) Appl. No.: 19/281,499

(22) Filed: Jul. 25, 2025

Related U.S. Application Data
(60) Provisional application No. 63/676,314, filed on Jul. 26, 2024.

(51) Int. Cl. G06N 20/00

(52) U.S. Cl. CPC G06N 20/00

(57) ABSTRACT

A system for low-latency state detection using gradient boosting. The system determines correlations between characteristics at certain locations and a target state. Using one or more locations determined to have a causal relation with the state, the system trains a gradient boosting-based model configured to accept, for input, a variant count for each of the one or more determined locations and output a confidence score indicating whether the first individual has the state. The system generates clusters for individuals based on impact features indicating an impact of the variant count on the confidence score. The clusters are associated with a manifestation of the state. The system can execute the machine learning model against a candidate individual to determine if they have the state, and in response to the state exceeding a threshold, determine the impact features to associate the individual with a cluster and determine likely manifestations of the state.

### CROSS-REFERENCE TO RELATED PATENT APPLICATIONS

This application claims priority to and the benefit of U.S. Provisional Application No. 63/676,314 filed Jul. 26, 2024, the entire contents of which is herein incorporated by reference.

### BACKGROUND

Machine learning models can identify patterns in data through training on examples that include a number of input characteristics (e.g., features) and known values for an outcome (e.g., labels). Machine learning models learn these mathematical relationships between the characteristics and the probability of the outcome by adjusting internal relationships to minimize a prediction error or loss function. Once trained, the machine learning model may be used to make predictions for new, unlabeled data.

Machine learning models can take a significant amount of time to execute, adding latency to user-facing applications that use them. Latency can lead to delays in updates to user interfaces causing the application to appear unresponsive. These problems are further amplified when working on data sets with a large number of inputs, for example, data for genetic screening.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate elements that are identical, functionally similar or comparable, and/or structurally identical.

FIG. 1 is a block diagram of a low-latency screening system, according to some implementations;

FIG. 2 is a flow diagram illustrating the data flow within the low-latency screening system of FIG. 1, according to some implementations;

FIG. 3 is a machine learning architecture used by the low-latency screening system, according to some implementations;

FIG. 4A is a plot of p-values used to select locations from which characteristics of an individual are obtained, according to some implementations;

FIG. 4B is a detailed plot of p-values used to select locations from which characteristics of an individual are obtained, according to some implementations;

FIG. 5 is a flow of operations for training a machine learning model for low-latency screening of individuals, according to some implementations;

FIG. 6 is a flow of operations for determining the likelihood that an individual has a particular state and determining manifestations of the state, according to some implementations;

### DETAILED DESCRIPTION

In the following description, reference is made to the accompanying drawings, which form a part hereof. In the drawings, similar symbols typically identify similar or analogous components unless context dictates otherwise. The illustrative embodiments described in the description, drawings, and claims are not limiting. Other embodiments may be utilized, and other changes may be made without departing from the spirit or scope of the subject matter presented here. It will be readily understood that the aspects of the present disclosure, as generally described herein and illustrated in the figures, can be arranged, substituted, combined, and designed in a wide variety of different configurations, all of which are explicitly contemplated and made part of this disclosure.

Previous methodologies for detecting genetic disorders or susceptibility to diseases based on an individual's genetic sequence rely on specialized panels tailored for the genetic disorder or disease. These methodologies may also use extensive phasing of (human leukocyte antigen) HLA haplotypes and use of proxy single-nucleotide polymorphisms (SNPs). Type 1 diabetes (TID) is one such disease that is tested for and has a correlation with some genetic variants. A genetic risk scoring (GRS) system has been developed that is capable of performing risk prediction for TID. The GRS system for TID is additive, each variant associated with TID contributes a particular amount to the overall risk. Additive tests such as the GRS system may suffer from multiple technical limitations that limit its usefulness. The additive nature of the GRS system increases the importance that all SNPs used by the test are available. For example, if a SNP is unavailable because of a testing error or because the SNP was not included in a panel for existing genetic results, the risk may be artificially lowered leading to inaccurate results.

To overcome this limitation, additional genetic testing may be ordered to determine a diagnosis, thus increasing patient cost especially if the patient has already had genetic testing performed (e.g., a reference panel such as TOPMed, retail versions of genetic testing, testing to determine ancestry, etc.). The need for additional testing may also limit the clinical usefulness of tests similar to the GRS due to the wait time while genetic tests are performed.

Additive tests such as the GRS may also ignore interactive (e.g., nonlinear, bivariate, etc.) effects between multiple SNPs (e.g., such as one variant or SNP cancelling or compounding the effects of another SNP) limiting the overall accuracy of the test. The tests also do not provide phenotype information related to the disease or genetic disorder. The presentation or manifestation of the disease may provide clinically relevant information that affects the proper treatment plan but cannot be obtained through the genetic test alone. For example, age of onset and/or susceptibility to (e.g., likelihood of, etc.) a secondary disease that is correlated with the tested genetic disorder or disease can guide practitioner recommendations. Susceptibility to cardiac disease or renal disease, for example, may guide treatment for persons with TID even in emergency situations. Thyroid disorders and/or other autoimmune diseases may also correlate with TID.

Previous methodologies may also use large data sets and complex machine learning architecture. Using these approaches can lead to increased latency (e.g., from executing the machine learning model) and transferring a large data set of genetic information. The increased latency can add to the time a patient waits for results and can limit the clinical usefulness of the technology. Complex machine learning models for large data sets may also require increased computational resources of a cloud computing architecture which can become unavailable during network outages. The diagnosis tool may also become unavailable during such network outages, further limiting the clinical and/or emergency use of traditional methods.

In contrast to conventional methodologies for testing for genetic disorders or diseases such as the GRS system for TID, systems and methods for low latency detection using machine learning (e.g., gradient boosting) can be performed allowing for increased accuracy including interactive effects between SNPs, robustness to SNPs that are not available from the genetic test, and more widespread use in the clinical setting.

The systems and methods described herein receive a training set comprising characteristics at locations on one or more structures for a plurality of individual (e.g., genetic information at loci of one or more chromosomes). The systems and methods may select, based on a statistical significance value, one or more selected locations, each selected location associated with one or more alternative characteristics. The amount of genetic information used as input to the evaluation process may thereby be reduced.

The systems and methods may train a machine learning model (e.g., using gradient boosting) to generate a confidence score related to the likelihood that an individual will develop a, a target genetic condition. The machine learning model may be configured to accept, at an input, a variant count of instances each selected location on the one or more structures on a first individual and output a confidence score indicating whether the first individual has the state. To determine a phenotype for patients likely to develop the condition, the systems and methods may generate a plurality of clusters for the plurality of individuals based on a plurality of impact features that indicate an impact on the value of the variant count corresponding to a respective selected location on the confidence score. Each cluster, for example, may be associated with one or more manifestations (e.g., phenotypes, presentations, etc.) of the state (e.g., condition).

After training has been performed, the systems and methods described here may receive, from a user interface presented at a client device, an identification of a candidate individual to evaluate the likelihood that the individual will develop the condition. The systems and methods may query a datastore using the identification to retrieve the genetic information for the one or more selected locations on chromosomes for the candidate individual and execute the machine learning model to generate a candidate confidence score indicating whether the candidate individual has or will develop the state (e.g., condition). Responsive to the candidate confidence score exceeding a threshold the systems and methods may repeatedly execute the machine learning model to determine candidate impact features for the candidate individual, and compare the impact features to those of the clusters identified during training to determine a phenotype for the individual.

The systems and methods described herein may use specialized training procedures and/or machine learning model types to facilitate accurate predictions, particularly when data is missing from the input. For example, gradient boosting-based algorithms (e.g., CatBoost, etc.) can allow for the model to predict the likelihood of the candidate individual developing the condition even when inputs have unknown values. Advantageously, the systems and method described herein can screen for a genetic disorder and/or disease with incomplete data for SNP variants and/or data from reference panels that may not have all SNP variants used as input to the model. During training it is also possible to remove certain inputs, for example, by providing a categorical input indicating that the value is not available. By training with batches from which various inputs (e.g., SNPs) were removed the machine learning model may learn to predict in the presence of missing data.

The systems and methods described herein may learn interactive effects providing multiple advantages compared to traditional methodologies like GRS systems. First, accuracy may be improved because of the increased expressive power of the nonlinear machine learning models used. Second, models that include interactive effects, in contrast to additive models, allow one input to compensate for another input. For example, if two inputs are strongly correlated, an additive model may assign an equal contribution to each input and if one is missing half of the contribution to the output is also lost, whereas a model with nonlinear effects (e.g., gradient boosting-based models and/or other machine learning models) may inherently assign equal contribution to both inputs if both are available and the entire contribution to a single input if the other is missing.

In addition, impact features that represent the contribution of an input (e.g., presence of an SNP variant) towards the overall likelihood of the individual having the genetic disorder or disease can be calculated. The impact features for an individual provide additional features useful in identifying a phenotype of persons with the genetic disorder or disease (e.g., TID). For example, the features may be used to determine age-of-onset of the disorder and/or susceptibility to correlated diseases. In some embodiments of the systems and methods presented herein, individuals having the genetic disorder or disease are clustered using a feature vector including the impact features. Each of the clusters may be associated with a different phenotype (e.g., different presentation of the disease, different manifestation of the disease, etc.). By determining the cluster that best represents a candidate individual it is possible to guide treatment and/or therapies for the disease.

Further, the choice of the machine learning model and the feature selection process allows for the system to be performed with minimal computational hardware. Latency of data transfer (e.g., the amount of genetic information) is reduced and computational times executing the machine learning model are further reduced. Further, decreased computational requirements allow the systems and methods described herein to be performed on edge compute devices (e.g., rather than on specialized cloud hardware) allowing for some implementations to be robust even in scenarios where the cloud hardware becomes unavailable due to a network outage.

In an example, a patient may enter a clinic having undiagnosed symptoms (e.g., rapid breathing, etc.). In order to determine appropriate tests to run, the practitioner may first perform a rapid genetic screen using the systems and methods presented herein. The practitioner may enter the patient's name and ask for them to consent to retrieving their genetic information from a previously performed ancestry test. The patient may enter a password or other authentication to allow retrieval of the genetic information. The systems and methods may use only a small amount of the genetic information and therefore data transfer is rapid. With the genetic information acquired, the systems and methods execute a machine learning method to determine the likelihood that this person would develop various genetic conditions. The machine learning model allows for low latency compared to more complex neural networks, causing little time to pass while awaiting results. In addition, because the machine learning model is trained such that it can account for missing data, no additional genetic tests are performed in the event that the ancestry test did not have all input information, further keeping with the low latency processing. The systems and methods inform the practitioner that the patient is at risk of TID. As a result, the practitioner may confirm the diagnosis with bloodwork. In addition, using the impact features developed during training, the systems and methods inform the practitioner that the person has a form of TID that may present with cardiovascular disease. The practitioner may develop a management plan to monitor heart function.

The advantages of the systems and methods disclosed allow for low latency detection and/or prediction of genetic disorders and/or diseases such as TID. The systems and methods may be used in a clinical or even emergency setting. Genetic information may be retrieved from a database, for example, a database of a retail provider of genetic testing, medical systems databases including previous genetic testing, or any other system where genetic information for a patient is stored. The patient may be screened rapidly for TID using already available information. In addition, the healthcare provider may be given additional information related to correlated diseases, potentially preventing mistreatment due to unknown conditions.

### Low-Latency Screening System

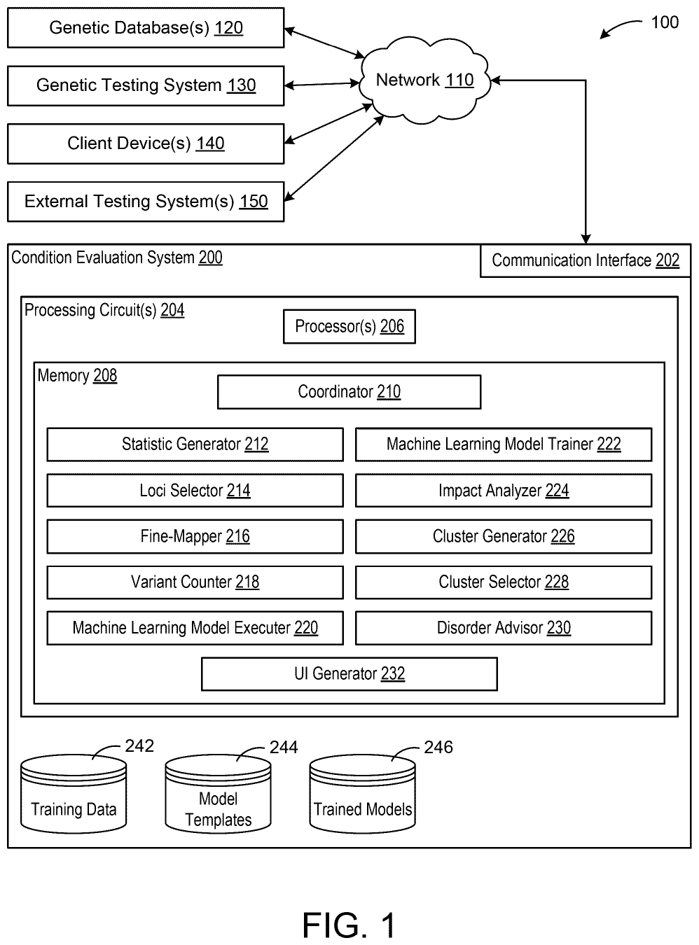

FIG. 1 is a block diagram of a low-latency screening system 100 configured to screen individuals for genetic disorders and/or diseases according to some embodiments. The low-latency screening system 100 may include one or more genetic databases 120, a genetic testing system 130, one or more external testing systems 150, one or more client devices 140, and a condition evaluation system 200, communicably connected via a network 110.

The network 110 can include routers, switches, antennas, computers, and any other hardware required to communicate information between the components of the low-latency screening system 100 (e.g., from the genetic testing system 130 to the condition evaluation system 200). A portion of the network 110 can be wireless and/or a portion of network 110 can be wired. Network 110 can include one or more networks with routers to facilitate data transfer between the different networks.

The low-latency screening system 100 may acquire genetic sequences, for example, from the one or more genetic databases 120. The genetic sequences may include nucleobases at a number loci within a persons genetic characteristics. The genetic sequences may include single-nucleotide polymorphisms (SNPs), for example, that are known to exist among a portion of the population. The low-latency screening system 100 may use trained machine learning models (e.g., gradient boosting models such as CatBoost or XGboost) to generate a likelihood that a genetic sequence is associated with an individual who has a target condition such as type 1 diabetes (TID), a genetic predisposition to cardiovascular disease, etc. Advantageously, the systems and methods described herein provide low-latency detection with a machine learning model having a minimal parameter set that can be used with incomplete genetic sequences (e.g., not having nucleobases for all loci used as input to the model). Minimal parameters may allow the model to be stored with minimal storage space and executed with computational requirements that facilitate deployment on edge devices (e.g., a handheld device, local computer, etc.) in addition to cloud implementations. The machine learning model may also account for missing data allowing for genetic screening to be performed without the time requirements or expense of running additional genetic panels for a patient that may already have some genetic information available. Speed of response can be of significance in both clinical and emergency care settings, with faster response times potentially allowing a practitioner access to susceptibility to many conditions, drugs, etc. before a treatment decision is made.

In some embodiments, the low-latency screening system 100 obtains a ground truth diagnosis or label, for example, based on other testing methodologies and/or symptoms of the condition. The ground truth values may be combined with the genetic information (e.g., sequence, SNP values, etc.) for the individual in a data set. The low-latency screening system 100 may determine a number of loci at which certain nucleobases or other genetic variations have a significant correlation with the target condition. The low-latency screening system 100 may train a machine learning model that can be used online. For example, to screen candidate individuals associated with candidate genetic material by executing the machine learning model. In some embodiments, the low-latency screening system 100 also generates impact features for the SNP values, etc. in the training data. Impact features indicate which genetic information contributes most heavily to the likelihood that a person has a condition and can be used to cluster individuals into different phenotypes (e.g., presentations or manifestations of the condition). Candidate individuals may be associated with a particular cluster, thereby allowing a practitioner to develop appropriate therapies for the condition (e.g., genetic disorder or disease).

The one or more genetic databases 120 may include results from previous genetic tests. For example, the one or more genetic databases 120 may include both healthcare databases and consumer databases (e.g., companies offering genetic testing for ancestry and health insights). In some embodiments, the one or more genetic databases 120 have an application programming interface (API) that accepts queries related to an individual's genetic information. For example, the one or more genetic databases 120 may respond to a query including a person's identification (e.g., username, name, customer number, etc.), an authorization (e.g., password, token, etc.), and/or a number of loci for which the corresponding nucleobase is requested. Providing only the queried nucleobases can reduce the latency and the computer resources necessary to transfer genetic data to the condition evaluation system 200 for screening. The condition evaluation system 200 may be configured to query the API with the appropriate request (e.g., GET, etc.) to obtain input data (e.g., characteristics, genetic information, etc.) for training the machine learning models and/or for screening an individual using the machine learning models.

In some embodiments, the low-latency screening system 100 includes a genetic testing system 130 to obtain genetic testing results for individuals that have not yet had genetic testing performed. The genetic testing system 130 may include any number or variety of genetic panels. In some embodiments, the genetic testing system 130 communicates the results to the condition evaluation system 200 for subsequent screening. In some embodiments, the genetic testing system 130 communicates results to the one or more genetic databases 120, and the condition evaluation system 200 subsequently queries the one or more genetic databases 120 to obtain the results. Advantageously, because the condition evaluation system 200 uses machine learning models configured to account for missing information, the genetic testing system 130 may use a general genetic panel and/or the genetic testing system 130 may use the same genetic panel for multiple conditions that the condition evaluation system 200 screens.

The one or more client devices 140 may include personal and/or clinical computer devices. In some embodiments, the one or more client devices 140 are configured to retrieve results from the condition evaluation system 200 and display those results to a practitioner and/or a patient. For example, the one or more client devices 140 may retrieve results using an application programming interface (API) provided by the condition evaluation system 200. Additionally, or alternatively, the one or more client devices 140 may generate a user interface (UI) to display the results of the screening (e.g., the diagnosis for one or more conditions). For example, the user interface may include one or more UI elements that show the likelihood a candidate individual has a target condition (e.g., genetic disorder or disease), a presentation (e.g., manifestation, appearance, etc.) of the condition, and one or more treatments (e.g., therapies, drugs, etc.) that are tailored towards a particular presentation of the condition. The UI may also include elements that initiate the screening, initiate retrieval of genetic information for the candidate individual, and/or allow a user to enter information (e.g., an identification and authorization) for the candidate individual. The candidate individual's information may facilitate query and retrieval of their genetic information from the one or more genetic databases 120.

The one or more client devices 140 may receive instructions (e.g., JavaScript, Cascading Style Sheets, etc.) from the condition evaluation system 200 for generating the user interface within a client application. The client application, for example, may be a standard application such as a web browser, or the client application may be a proprietary application designed for interaction with the condition evaluation system 200. The condition evaluation system 200 may be configured to receive electronic signals and/or data via an API from the one or more client devices 140. For example, transmission of the electronic signals/data from the one or more client devices 140 may be instantiated by a user's interaction with one or more of the UI elements.

In some embodiments, the low-latency screening system 100 includes the one or more external testing systems 150. The one or more external testing systems 150 may include systems of labs or other providers of genetic testing. The low-latency screening system 100 may use the one or more external testing systems 150 for genetic testing when genetic information for a candidate individual is not available. The condition evaluation system 200 may queue a genetic test via an API provided by the one or more external testing systems 150. After the test is performed, the results may be obtained, for example, by querying the one or more genetic databases 120 (e.g., the genetic database associated with the external testing system used). In some embodiments, the one or more external testing systems 150 are used when a local (e.g., attached, on the same network, etc.) genetic testing system 130 is not available. In some embodiments, the one or more external testing systems 150 are used if the speed of results is not imperative (e.g., the candidate individual is not waiting and/or in an emergency situation). The condition evaluation system 200 may queue a genetic panel that is similar to that of the genetic testing system 130. For example, the genetic panel may be a generic genetic panel that may be used for the evaluation of one or more target conditions of the condition evaluation system 200.

The condition evaluation system 200 may include a communications interface 202 to facilitate communication of data (e.g., information, images, etc.) to other devices and/or systems on the network 110. The condition evaluation system 200 may also include a processing circuit 204 having one or more processors 206 and memory 208. For example, the processor 206 may be configured to execute instructions contained on the memory 208.

The condition evaluation system 200 may be distributed across one or more hardware devices. For example, the one or more processors 206 and/or the memory 208 may be implemented within a cloud computing architecture. In some embodiments, the condition evaluation system 200 may be configured to scale the number of processors 206 (e.g., the amount of hardware) allocated to executing any of the instruction sets contained within the memory 208. The instructions may also be copied and provided to another computer within the cloud computing architecture to further scale the capability of the condition evaluation system 200. For example, the number of processors 206 executing the functions of the condition evaluation system 200 may increase if multiple models are being trained simultaneously.

The one or more processors 206 may be or include one or more general-purpose or specific-purpose processors, application-specific integrated circuits (ASIC), one or more field programmable gate arrays (FPGAs), a group of processing components, or other suitable processing components. The processors 206 may be configured to execute computer code and/or instructions stored in the respective memory 208 or received from other computer-readable media (e.g., CDROM, network storage, a remote server, etc.). The processors 206 may be configured in various computer architectures, such as graphics processing units (GPUs), distributed computing architectures, cloud server architectures, client-server architectures, or various combinations thereof. One or more first processors (e.g., primary processors) can be implemented by a first device, such as an edge device, and/or while one or more second processors can be implemented by a second device, such as a server or other device that is communicatively coupled with the first device and may have greater processor and/or memory resources.

The memory 208 may include one or more devices (e.g., memory units, memory devices, storage devices, etc.) for storing data and/or computer code for completing and/or facilitating the various processes described in the present disclosure. The memory 208 may include random access memory (RAM), read-only memory (ROM), hard drive storage, temporary storage, non-volatile memory, flash memory, optical memory, or any other suitable memory for storing software objects and/or computer instructions. The memory 208 may include database components, object code components, script components, or any other type of information structure for supporting the various activities and information structures described in the present disclosure. The memory 208 may be communicably connected to the processors 206 and can include computer code for executing (e.g., by the processors 206) one or more processes described herein.

In some embodiments, the condition evaluation system 200 provides at least two modes of operation. For example, the condition evaluation system 200 may include a training mode (e.g., learning mode, offline mode, etc.) and an evaluation mode (e.g., inference mode, online mode, etc. In some embodiments, during training, the condition evaluation system 200 processes a set of genetic information for multiple individuals for which the diagnosis (e.g., whether or not the person developed a target condition) is known. The condition evaluation system 200 may, during training mode, identify loci on chromosomes that are correlated with the target condition, generate a trained machine learning model using information from the identified loci, and generate clusters based on which and/or how the various loci contribute to a person's development of the condition or phenotype (e.g., symptoms, correlated diseases, presentations, etc.). Subsequently, during evaluation mode, the condition evaluation system 200 may use the information learned in the training mode to determine whether a candidate individual is likely to develop the target condition, and if so, the condition evaluation system 200 may determine how the condition will present.

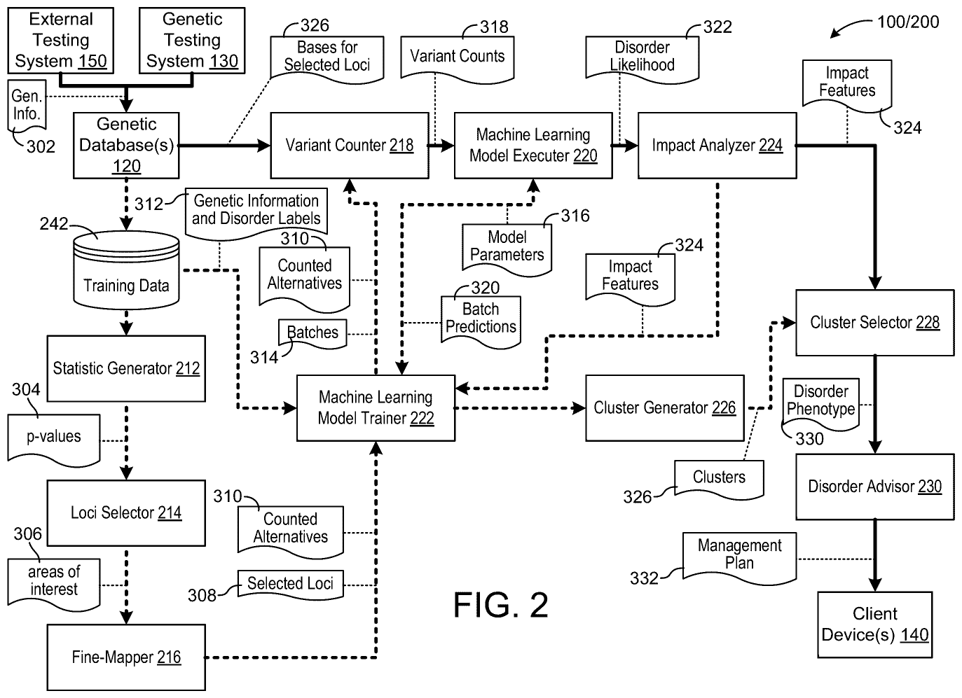

In some embodiments, the condition evaluation system 200 includes a coordinator 210, a statistic generator 212, a loci selector 214, a fine-mapper 216, a variant counter 218, a machine learning model executor 220, a machine learning model trainer 222, an impact analyzer 224, a cluster generator 226, a cluster selector 228, a disorder advisor 230, and a UI generator 232. The coordinator 210 may be configured to control the timing and flow of data through the other circuitry or modules of the condition evaluation system 200. For example, the coordinator 210 may cause the modules or circuits to execute in a specific order to perform the function of the condition evaluation system 200. In some embodiments, the coordinator 210 may route the information and/or outputs of other modules that are dependent on the information or use the information as an input. For example, the coordinator 210 may cause the data output from each of the components of the condition evaluation system 200 to flow to the next components as shown in FIG. 2. The condition evaluation system 200 may also include a training data storage 242, a model template storage 244, and a trained models storage 246.

FIG. 2 is a flow diagram illustrating the data flow within the condition evaluation system 200 during the generation of the machine learning models (e.g., during model training) and during evaluation of characteristics (e.g., genetic information) of a candidate individual for a target condition according to some embodiments. The data flow for training the machine learning models according to some embodiments is shown with a broken line, whereas the data flow for evaluation of a candidate individual according to some embodiments is shown with a solid line. Both FIGS. 1 and 2 can be used to understand some embodiments of the low-latency screening system 100 and the condition evaluation system 200. FIG. 1 illustrates certain structural relationships of the components and/or instruction sets of the low-latency screening system 100 and condition evaluation system 200 according to some embodiments, whereas FIG. 2 illustrates certain data communication paths between the components and/or instruction sets of the low-latency screening system 100 and condition evaluation system 200. The type of data input and output from many of the features (e.g., instruction sets, etc.) of the condition evaluation system 200 are also shown in FIG. 2 according to some embodiments.

Referring to FIG. 2, the one or more external testing systems 150, the one or more genetic databases 120, and/or the genetic testing system 130 may be used to populate the training data storage 242. Genetic information 302 (e.g., test and/or panel results) may be transferred from the one or more external testing systems 150 or the genetic testing system 130 to be stored in the one or more genetic databases 120. In some embodiments, the systems (e.g., the one or more external testing systems 150, the one or more genetic databases 120, and/or the genetic testing system 130) push all new genetic information into the training data storage 242. In some embodiments, the condition evaluation system 200 requests (e.g., polls, etc.) new data from the systems and populates the training data storage 242. Some of the genetic information may include a diagnosis (e.g., a label) associated with the genetic information. For example, a number of the genetic information entries in may include the ultimate diagnosis (e.g., either as having or not having or developing or not developing) for the condition. Data for which the diagnosis is known may be used for supervised training of the machine learning models of the condition evaluation system 200.

In some embodiments, the training data storage 242 filters the data used for training. Certain data may be discarded or not provided to the condition evaluation system 200 for training. For example, if, for a record, a significant amount of data is unavailable, the genetic information record to be an outlier, or other characteristics of the data indicate that the quality may be impaired, the training data storage 242 may determine that the data record should not be used for training. In some embodiments, the training data storage 242 provides all the potential training data to the condition evaluation system 200, and the condition evaluation system 200 (e.g., by way of the coordinator 210) determines which data is appropriate to use for training (e.g., high quality, below a threshold amount of missing data, not an outlier, etc.).

Referring to FIG. 2, the broken arrows represent paths for data communication within the condition evaluation system 200 according to some embodiments. The flow of data during training may start with acquiring training data from the training data storage 242 and may end with populating the variant counter 218 with the loci from which genetic information is used to predict development of the condition, the machine learning model executor 220 with a trained machine learning model, and the cluster selector 228 with clusters representing phenotypes for the condition.

The condition evaluation system 200 may perform feature selection to determine which characteristics (e.g., nucleobase at a particular locus or location on a chromosome) are related (e.g., correlated, causal, etc.) to the genetic condition. Advantageously, by performing feature selection, a minimal data set may be required to evaluate a candidate individual for a target condition. Data transfer and computations for model execution may thereby be reduced. In some embodiments, feature selection functionality is divided between the statistic generator 212, the loci selector 214, and the fine-mapper 216.

The statistic generator 212 may be configured to perform a coarse screening of the characteristics of an individual's genetic information correlated to a target condition. For example, the statistic generator 212 may receive training data sets including genetic information and disorder labels 312. The statistic generator 212 may generate a value for a test statistic for each locus on chromosomes of an individual (e.g., each nucleobase, SNP, etc.). The test statistic may be selected based on its ability to identify when a null hypothesis that two classes (e.g., developing or not developing) the target condition do not have the same distribution and therefore represent a potential linkage (e.g., correlation, causal relationship, etc.) between a characteristic or a particular SNP or nucleobase at a particular locus and the target condition. Examples of test statistics may include statistics based on counting the number of times or determining the ratio of times a variant is present in the group developing the condition and in the group not developing the condition (e.g., a binomial test statistic or a z-statistic) or statistics based on comparisons between members of each of the groups (e.g., developing or not developing the condition). For example, the Mann-Whitney U-test or another ranking-based test statistic may be used. In some embodiments, a ranking based test is used to incorporate information related to whether an SNP or a particular nucleobase occurs at a particular locus at both of a pair of chromosomes, on one of a pair of chromosomes, or occurs on neither chromosome of the pair.

In some embodiments, the statistic generator 212 determines a p-value 304 for the test statistic. The p-value may be a score indicating how likely the result for a single locus or characteristic is given the value for the test statistic. For example, the p-value may represent the probability that the test statistic meets or exceeds its value under the null hypothesis (e.g., that both groups have the same distribution of variants for the tested locus). For some test statistics, the p-values for a particular value of a test statistic can be determined by integrating (e.g., numerically) the probability distribution of the test statistic to the particular value. For some statistics, the values have been stored in a table that may be consulted by the statistic generator 212.

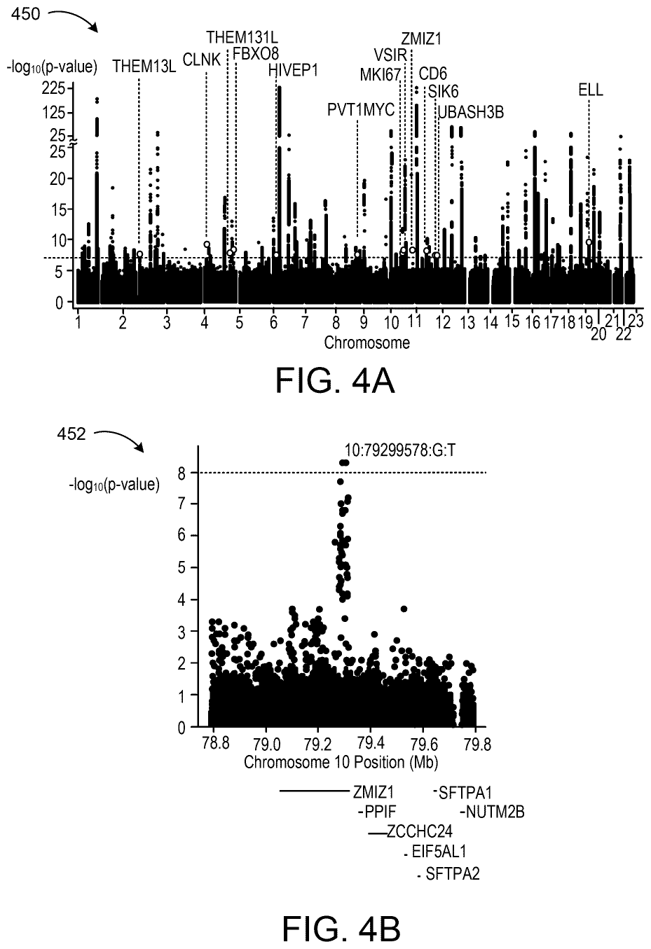

FIG. 4A shows an example plot 450 of the p-value for multiple genetic locations (e.g., loci) of an individual according to some embodiments. In plot 450, the p-value represents a significance of a locus to the development of TID in an individual. Higher values of the negative of the base ten logarithm of the p-value indicate that data was less likely to occur from two groups having the same distributions of nucleobases at that locus, thereby potentially indicating that variants at that locus are important to determine if the condition will be developed. FIG. 4B shows plot 452 a zoomed (e.g., detailed) version of a portion of the plot 450 according to some embodiments. As shown in FIG. 4B, significant p-values may form a cluster around nearby loci. In some embodiments, each cluster is further analyzed by the fine-mapper 216 to determine a credible set of variants that may have a causal relationship with the target condition.

In some embodiments, the loci selector 214 is configured to select a number of loci or groupings of nearby (e.g., spatially collocated, etc.) loci based on the p-values 304. The loci selector 214 may receive the p-values 304 from the statistic generator 212 and provide the groupings of nearby loci (shown as areas of interest 306) to the fine-mapper 216. The loci selector 214 may compare the p-value of each locus to a threshold related to a significance level. For example, the loci selector 214 may select loci for which the p-value is less than a threshold (e.g., less than 10⁻⁸) or −log₁₀(p-value) is greater than a threshold (e.g., greater than 8). The threshold related to the significance for the p-value may be lower than typical significance tests (which may use, for example, 0.05). Using a lower threshold (e.g., closer to zero) may prevent a significant number of loci that do not have a correlation with the target condition, but had a lower test statistic by random chance from being included in the inputs of the machine learning model. Advantageously, an appropriate number of loci may be selected as input to the genetic evaluation, preventing the need for expensive and/or more comprehensive genetic panels. In some embodiments, the threshold is adjusted based on the number of loci for which the p-values are calculated. For example, the threshold may be divided by the number of loci or divided by the number of loci multiplied by a scaling factor (e.g., 10, 20, etc.).

In some embodiments, the loci selector 214 uses a selection criterion that is based on more than the p-value of the test at a particular locus. For example, the loci selector 214 may select loci based on a criterion that searches for a number of consecutive loci having a p-value less than a significance threshold or a window of n loci for which at least m loci have a p-value less than a significance threshold.

The condition evaluation system 200 may include a fine-mapper 216 to narrow down the number of loci to use as inputs to predict the development of a genetic condition. In some embodiments, the fine-mapper 216 is configured to receive the areas of interest 306 from the loci selector 214 and provide a number of selected loci 308 that appear to have a causal relationship with the target condition.

In some embodiments, the fine-mapper 216 selects from each area of interest, a locus having the most significant (e.g., smallest) p-value. The fine-mapper 216 may also provide alternative nucleobases (e.g., variants), shown as counted alternatives 310, at the locus that appear to correlate with the condition. The counted alternatives 310 may be a set of alternative nucleobases commonly found at the selected locus in the group of individuals from the training data that have developed the condition. In some embodiments, the counted alternatives 310 are found by selecting the most common variant in the group of individuals from the training data that have developed the condition or by selecting all variants, from the group of individuals from the training data that have developed the condition, which satisfy a variant selection criterion.

In some embodiments, the fine-mapper 216 performs a genetic fine-mapping procedure to determine selected loci 308 and variants (e.g., the counted alternatives 310) that have a causal relationship with the genetic condition. For example, Bayesian fine-mapping may be performed to determine, for each locus of the areas of interest 306 and the respective SNPs that may occur, a posterior probability that the respective SNP has a causal relationship with the genetic condition. In some embodiments, the locus and the SNP having the greatest posterior probability are selected from each of the areas of interest 306. The SNP may be added to the counted alternatives 310 for the respective locus. In some embodiments, multiple loci and/or SNPs having a posterior probability greater than a threshold probability are selected from each of the areas of interest 306. The SNP may be added to the counted alternatives 310 for each loci selected. If more than one SNP at a respective locus satisfies the probability threshold, each SNP satisfying the threshold at the respective locus may be added to the counted alternatives 310. Alternatively, the locus may be included in the set of selected loci 308 more than once, and each entry of the locus may be associated with a different SNP for the counted alternatives 310. In some embodiments, a credible set comprising a minimal number of loci and/or SNPs for which at least one locus and SNP is likely (e.g., with 95% confidence) is determined. The loci and/or SNPs may be selected from the credible set for each of the areas of interest 306; for example, the fine-mapper 216 may select all loci of the credible set.

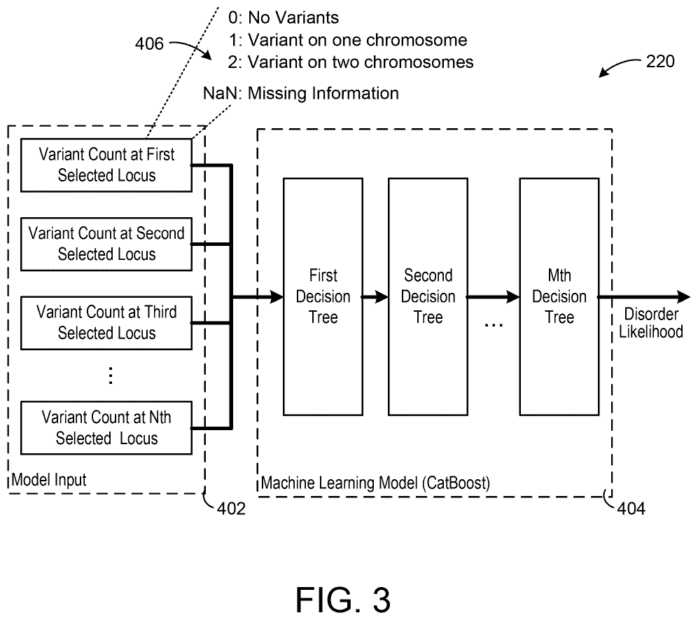

The selected loci 308 and the respective counted alternatives 310 at each of the selected loci 308 may be used as input to the evaluation process performed by the condition evaluation system 200. In some embodiments, the evaluation of genetic information (e.g., the screening for the genetic condition) is performed using a machine learning model. FIG. 3 shows the machine learning model architecture trained during training mode and executed during evaluation mode of the genetic information according to some embodiments. The machine learning model architecture is shown to have a model input 402 and a machine learning model 404.

In some embodiments, each of the selected loci 308 or each entry for the selected loci 308 (if the same locus is included more than once) has an associated input in the model input 402. The input provided to the machine learning model may be encoded by the model input 402 in a number of ways. For example, the input may represent the nucleobase present in the individual at the locus associated with an input. The input may be a binary input representing whether a variant of the counted alternatives 310 was present at the loci (e.g., on either of the chromosomes of the pair where the locus is located). In some embodiments, the input comprises an enumeration or count 406. The count 406 may represent the number of chromosomes of the pair where the locus is located that include a counted alternative of the counted alternatives 310. For example, to perform the count, the locus may be located on each of the pair of chromosomes, the nucleobase at the locus may be compared to the counted alternatives, and for each of the pair that includes a nucleobase which is part of the counted alternatives, the count may be incremented. In some embodiments, the inputs also accept an indication that the data is not available (e.g., by way of a NaN value, NULL value, etc.). Determining the variant count is described in more detail with respect to variant counter 218.

The machine learning model 404 may include any machine learning model including a neural network, a support vector machine, decision tree, etc. In some embodiments, a gradient boosting architecture is used. Advantageously, gradient boosting may use a smaller number of parameters and may be executed rapidly (e.g., with low latency). Additionally, some gradient boosting algorithms may have direct support for categorical inputs (e.g., from an enumeration of 0, 1, 2, or NaN). Gradient boosting combines a number of weakly trained component models, for example, by adding the outputs together. Each component model may be any class of model. For example, any component model may be a nonlinear regression model, a support vector machine, or a decision tree (e.g., as shown in FIG. 3). Each component model may use any number of the input variables (e.g., the variant counts). For example, a component model may use inputs 1, 8, and 21, whereas a second component model may use inputs 1, 9, and 12. In some embodiments, each component model is trained to predict the difference between the ground truth (e.g., a likelihood that the individual would develop the condition) and the output of the previous machine learning models (or a scaled version of the previous outputs).

Referring again to FIGS. 1 and 2, the machine learning model trainer 222 may be configured to determine parameters for the machine learning model (e.g., component models and their parameters). The machine learning model trainer 222 may generate a machine learning model 404 having the number of inputs indicated by the selected loci 308 received from the fine-mapper 216. The machine learning model trainer 222 may generate a batch 314 including a number of training samples each having nucleobases for the selected loci 308 and the ground truth diagnosis of whether the individual developed the condition. The machine learning model trainer 222 may also request and/or receive a model form (e.g., for a component model) from the model template storage 244. Training a component model for the machine learning model 404 may include adjusting parameters of the component model to improve a performance metric (e.g., loss metric). Training may be performed using, for example, a number of batches 314. For each batch the machine learning model trainer 222 uses the variant counter 218 and the machine learning model executor 220 to determine a prediction with the current parameters of the component model and adjust the parameters based on the performance metric. After a number of batches are performed or another stopping criterion is reached for training of a component model, the machine learning model trainer 222 may store the component model, multiply it by a component weight, and begin training the next component model based on the residual (e.g., the difference) between the ground truth and the sum of the weighted preceding models.

During training, the machine learning model trainer 222 may provide a training sample from the genetic information for a batch 314 (e.g., the nucleobases at the selected loci) to the variant counter 218. The counted alternatives 310 may also be provided to the variant counter 218 by the machine learning model trainer 222. For each respective locus of the selected loci 308, the variant counter 218 may count the number of chromosomes that include any of the SNPs in the set of counted alternatives 310 for the respective locus. The variant counter 218 may output a variant count 318 indicating that the any of the counted alternatives 310 for the locus occurred on zero of the chromosomes of the pair, one chromosome of the pair, or both chromosomes of the pair. For example, the variant count 318 output from the variant counter 218 for each of the selected loci may be used one input of the model input section 402. The variant counter 218 may provide the variant counts 218 for each training sample of the batch to the machine learning model executor 220.

The machine learning model executor 220 may be configured to generate a score related to the likelihood that an individual having the variant counts input to the machine learning model will develop the condition (e.g., shown as disorder likelihood 322). It may receive the variant counts 318 from the variant counter 218 for each of the selected loci 308 and execute a machine learning model configured to accept, as input, the variant count 318 and determine a disorder likelihood 322. The machine learning model executor 220 may be configured to execute any type of machine learning model, including, but not limited to, gradient boosting-based models, regression models, support vector machines, etc. The machine learning model executor 220 may be configured to generate disorder likelihood predictions for each training sample of a batch (e.g., shown as batch predictions 320).

The machine learning model trainer 222 may, using the batch predictions 320 from the machine learning model executor 220, determine a gradient of the performance metric with respect to parameters of the model (or component model in the case of a gradient boosting algorithm). The machine learning model trainer 222 may adjust the parameters to cause an improvement in the performance metric (e.g., for the current batch of training samples).

After the model has been trained, the machine learning model trainer 222 may request a final execution of the machine learning model for each training sample. During the final execution for each training sample, the machine learning model trainer 222 (e.g., or coordinator 210, etc.) may request the impact analyzer 224 to determine impact features 324 for each training sample of the training set. The impact features 324 may be used by subsequent training functionality, for example, to determine clusters of different phenotypes (e.g., different presentations, manifestations, etc.) for the condition.

The impact analyzer 224 may be configured to determine the impact features 324 for each of the variant counts (e.g., their corresponding loci) input to the machine learning model. The impact features 324 may be calculated for training samples during training and/or for a candidate individual during evaluation. During training, the impact analyzer 224 may be configured to generate impact features 324 for each of the training samples.

Impact features 324 may represent a contribution to the output of the machine learning model (e.g., the disorder likelihood 322) of each variant count (e.g., the corresponding locus). In some embodiments, the impact features 324 are different for each sample (e.g., training sample or genetic information for a candidate individual). Impact features may be calculated such that the sum of the impact features for each variant count of a sample is equal to the disorder likelihood 322 output minus the average disorder likelihood 322 (e.g., averaged over the entire population). In some embodiments, the impact analyzer 224 is configured to calculate Shapley values for each variant count of a sample. For example, the impact analyzer 224 may calculate Shapley additive explanations (SHAP) for each of the variant counts of a sample.

The impact analyzer 224 may calculate the impact features 324 by repeatedly executing the machine learning model (e.g., using the machine learning model executor 220). For example, the impact analyzer 224 may execute the machine learning model with different inputs (e.g., variant counts) unavailable. To determine the contribution to the disorder likelihood 322 of a particular variant count, the impact analyzer 224 may calculate the difference between the output of the machine learning model with the particular variant count available and without the particular variant count available. A weighted sum of the differences may be generated for a number of differences where each difference has a different set of variant counts available. When a particular variant count is not available during calculations by the impact analyzer 224, the impact analyzer 224 may marginalize the contribution of the variant count over the probability distribution of that variant count. For example, the impact analyzer 224 may determine a weighted average of the contribution of each potential value (e.g., 0, 1, or 2) of the variant count. In some embodiments, the component models are decision trees, and the number of training samples that traverse a branch of the decision tree are stored to facilitate efficient calculation of the impact features 324 (e.g., Shapley values). During training, the impact analyzer 224 or the machine learning model trainer 222 may provide the impact the impact features 324 for each training sample to the cluster generator 226.

In some embodiments, the cluster generator 226 may generate a feature vector for each training sample using the impact features 324. The feature vectors may be part of a q-dimensional vector space where q is the number of variant count inputs to the machine learning model executed by the machine learning model executor 220. The cluster generator 226 may generate clusters of the feature vectors using an unsupervised training algorithm. For example, the cluster generator 226 may use clustering algorithms such as k-means clustering or other centroidal models; density-based spatial clustering of applications with noise (DBSCAN), Ordering Points To Identify the Clustering Structure (OPTICS), or other density-based methods; hierarchical clustering; expectation-maximization; etc. The number of clusters identified by the cluster generator 226 may be predefined, for example, based on an expected number of phenotypes for the target condition. In some embodiments, the cluster generator 226 may generate a clustering metric to determine an appropriate number of clusters. The number of clusters may be chosen based on a highest clustering score or may be chosen based on a number of clusters after which adding clusters does not significantly improve a fitting score. For example, the number of clusters may be chosen based on a highest Calinski Harabasz score.

In some embodiments, the cluster generator 226 associates one or more phenotypes (e.g., presentations, symptoms, manifestations, correlated diseases, etc.) to the clusters generated. The cluster generator 226 may map the phenotypes based on known impact of variants, SNPs, etc. For example, the cluster generator 226 may determine a cluster that includes an elevated impact from variants known to be associated with a particular phenotype. In some embodiments, the cluster generator 226 may use language model to semantically compare content from research articles, etc. to a text-based description of the cluster indicating variants having an elevated impact within the cluster. In some embodiments, the cluster generator 226 uses the UI generator 232 to coordinate annotation of the clusters with a phenotype. For example, a user interface generated by the UI generator 232 may display the clusters and allow a user to annotate each cluster with one or more phenotypes. In some embodiments, the phenotypes are known, and a user can interact with the user interface to associate the phenotypes with the clusters. For example, the user may drag and drop one or more phenotypes onto a cluster.

In some embodiments, the cluster generator 226 performs principal components analysis (PCA) to facilitate clustering. For example, performing PCA may reduce the number of computations performed during cluster generation. Clustering may be performed on a reduced set of principal components rather than the feature vector of impact feature values. In some embodiments, the cluster generator 226 performs nonlinear dimensionality reduction. The nonlinear features extracted can facilitate viewing the clusters in a 2 or 3 dimensional plot, for example, in a user interface. For example, nonlinear dimension reduction techniques such as Uniform Manifold Approximation and Projection (UMAP) may be used. The cluster generator 226 may use a nonlinear dimension reduction technique that preserves relationships between nearby points, thereby allowing clusters to be maintained in a lower dimensional space. Clusters 326 generated by the cluster generator 226 may be provided (e.g., communicated) to the cluster selector 228 to facilitate assignment of impact features for a candidate individual to a particular cluster. The cluster of the candidate individual may indicate a phenotype (e.g., a manifestation or presentation of the genetic condition). In some embodiments, the cluster generator 226 may generate a representative feature vector for each cluster of the clusters 326. For example, the clusters 326 may determine a representative vector based on the average of the feature vectors (e.g., from training samples) or a statistic of the feature vectors (e.g., a vector minimizing an objective function such as sum of 1-norms, etc.)

In some embodiments, evaluation (e.g., screening, etc.) of a candidate individual for a target condition follows a different path through the components (e.g., instruction sets, circuits, etc.) of the condition evaluation system 200. According to some embodiments, data flow during candidate evaluation follows the path shown by the solid arrows in FIG. 2. In general, candidate evaluation includes obtaining genetic information related to the candidate individual for the selected loci, executing a trained machine learning model using the genetic information (e.g., variant counts) for the selected loci as inputs, and presenting to a user a likelihood of developing the target condition and/or providing a treatment plan and/or therapies if the candidate is likely to develop the condition.

During evaluation, operation of the variant counter 218, the machine learning model executor 220, and the impact analyzer 224 is similar to their respective operations during training. During evaluation, the components of the condition evaluation system 200 may operate on a single set of genetic information for a candidate individual rather than a training batch or the entire training set for which a diagnosis of the condition is already known. For example, the variant counter 218 may receive nucleobases for the selected loci 308 (e.g., those selected by the loci selector 214 and/or the fine-mapper 216 during training) and for each selected locus and respective set of counted alternatives, the variant counter 218 may output a number equal to the number of chromosomes, of the pair of chromosomes for the locus, on which a member of the respective set of counted alternative nucleobases occurs at the locus. In some embodiments, the variant counter 218 outputs a separate indication if the genetic information is not available. The variant counter 218 thereby may determine the number of chromosomes on which particular SNPs occur at the selected locus. In some embodiments, the condition evaluation system 200 performs evaluation for a plurality of conditions. The variant counter 218 may request the nucleobases for a respective machine learning model for each of the plurality of conditions. The variant counter 218 may generate the variant counts 318 for the union of the inputs to all machine learning models (e.g., to reduce repeated computations) or the variant counter 218 may generate the variant counts 318 for each machine learning model as that model is executed (e.g., to reduce the memory used).

The machine learning model executor 220 may receive the variant counts 318 from the variant counter 218 and apply the variant counts 318 as input to the trained machine learning model (e.g., generated during training by the machine learning model trainer 222). In some embodiments, the machine learning model is stored in the trained models storage 246 and provided to the machine learning model executor 220 at evaluation time. In some embodiments, the condition evaluation system 200 performs evaluation for a plurality of conditions (e.g., genetic disorders, etc.). The machine learning model executor 220 may request a respective machine learning model for each of the plurality of conditions to be evaluated. The machine learning model executor 220 may execute the respective machine learning model, thereby generating a disorder likelihood 322 for each of the evaluated conditions. Similarly, the impact analyzer 224 may be executed to determine impact features impact features 324 for the candidate individual and for each evaluated condition. In some embodiments, the impact analyzer 224 and downstream functionality are executed responsive to the disorder likelihood 322 satisfying a threshold criterion. For example, the machine learning model executor 220 (or the coordinator 210) may initiate execution of the impact analyzer 224, the cluster selector 228, and the disorder advisor 230 if the disorder likelihood 322 is greater than a threshold (e.g., 0.8, 0.9, etc.). If the disorder likelihood 322 fails to satisfy the threshold criterion, the condition evaluation system 200 may communicate the disorder likelihood 322 or the negative result to the one or more client devices 140 (e.g., to update a user interface, or view thereof).

The cluster selector 228 may be configured to receive impact features 324 for a candidate individual and associate the impact features 324 of the candidate individual with a cluster of the clusters 326. The impact features 324 may be arranged (e.g., organized, constructed, etc.) into a feature vector and compared to the clusters 326. For example, each cluster of the clusters 326 may include a representative feature vector (e.g., average, centroid, median, etc.) that can be compared to the impact features 324 for the candidate individual. The cluster selector 228 may calculate a distance metric between the feature vector for the candidate individual and the representative vectors. The cluster selector 228 may associate the feature vector (and thereby the candidate individual) with the cluster having the minimal distance between the feature vector and the representative feature vectors for the cluster. In some embodiments, the cluster selector 228 uses multiple representative vectors for the cluster (e.g., sampled from a distribution) or a number of feature vectors from the training set to determine the cluster to associate with the feature vector of the candidate individual. For example, the distance of all representative features vectors or all features vectors form the training set may be summed or averaged (e.g., weighted or not weighted) to determine a distance metric for each cluster, which can in turn be used to associate the feature vector of the candidate individual with a cluster having the smallest distance metric and/or satisfying a distance criterion.

The cluster selector 228 may associate the feature vector for the candidate individual with a particular cluster. In some embodiments, the clusters are associated with a phenotype. For example, patterns in the loci and/or SNPs that contribute heavily to the likelihood of developing the evaluated condition may be indicative of the presentation (e.g., manifestation, appearance, occurrence, etc.) of the evaluated condition. By associating the impact feature vector with a respective cluster of the clusters 326, the cluster selector 228 may determine the disorder phenotype 330 (presentation, etc.). For example, the cluster selector 228 may associate the condition with a phenotype that was associated with the cluster during training (e.g., during annotation by the cluster generator 228). In some embodiments, a particular disorder phenotype 330 is associated with a management plan 332 (e.g., therapies, treatments, coping plans, dietary restrictions, drug interactions, restricted medical procedures, etc.) as well as secondary diseases or disorders that may be associated with the evaluated condition.

In some embodiments, the disorder advisor 230 provides the management plan 332 based on the disorder phenotype 330. The management plan 332 may be stored in a database; for example, each cluster (and phenotype) may have a predefined management plan 332. For example, the disorder advisor 230 may provide a management plan for the phenotype associated with the cluster by the cluster generator 228. In some embodiments, the disorder advisor 230 provides the disorder phenotype 330 to one or more external systems to request additional and/or up-to-date information related to the phenotype. For example, the disorder advisor 230 may use a search engine to retrieve additional information. The disorder advisor 230 may, additionally or alternatively, use a large language model (e.g., with retrieval augmented generation) to retrieve additional information and distill the information for a user. The disorder advisor 230 may provide the management plan 332 to the one or more client devices 140 (e.g., to be displayed within a user interface view).

The UI generator 232 may be configured to provide instructions (e.g., JavaScript, Cascading Style Sheets, etc.) to the one or more client devices 140 for generating the user interface within a client application. The client application, for example, may be a standard application such as a web browser, or the client application may be a proprietary application designed for interaction with the condition evaluation system 200.

The user interface for the condition evaluation system 200 may provide a number of interface elements to facilitate interaction with the one or more features or components of the condition evaluation system 200. The user interface may provide an interface element that initiates the training procedure. In some embodiments, the user interface provides interface elements for data entry. For example, the user interface may provide interface elements that allow a user to select a target condition for the training session. Additionally, the user interface may provide interface elements allowing the user to modify training hyperparameters such as the p-value threshold or other types of selection criteria for the loci selector 214, methodologies for fine-mapping, the type of machine learning model (e.g., from the model template storage 244), and training parameters such as batch size, amount of validation data, etc. The user interface may also provide the results of any of the steps within the training procedure. For example, the UI generator 232 may generate plots such as the significance plot 450 and the local significance plot 452, fine-mapping figures, receiver operating characteristics, clustering plots (e.g., after PCA and/or UMAP), Shapley features for the samples of the training set, precision and recall curves, etc.

In some embodiments, the UI generator 232 may also generate a user interface and/or respective user interface elements for evaluation. For example, the user interface may include one or more interface elements to provide an identity of a candidate individual. In some embodiments, the identity is used to query the one or more genetic databases 120 for genetic information (e.g., SNPs, nucleobases, etc.) for the candidate individual. For example, the user interface may allow text entry of a person's name, a customer number, government identification number, etc. Additionally or alternatively, the user interface may identify a person by fingerprint, facial recognition, or other biometric that may be available for an unresponsive individual. In some embodiments, the one or more user interface elements may also provide a user interface element that allows for an individual to enter credentials or authorization (e.g., password, token, etc.) to access the genetic information. In some embodiments, the candidate individual may have preauthorized certain categories of entities (e.g., hospitals, emergency rooms, etc.) access to their genetic information. The entity may provide their credentials or authorization to access the genetic information.

The user interface may also provide one or more interface elements that provide results of the evaluation. For example, the UI generator 232 may update the user interface (e.g., send new display instructions, JavaScript, etc.) with the results of the evaluation. The user interface may be updated to display the disorder likelihood 322. In some embodiments, the user interface may also be updated to display the impact features 324, the impact feature vector within the two or three-dimensional cluster plot from the training data, the phenotype associated with the two or three-dimensional cluster, and/or a management plan for the phenotype.

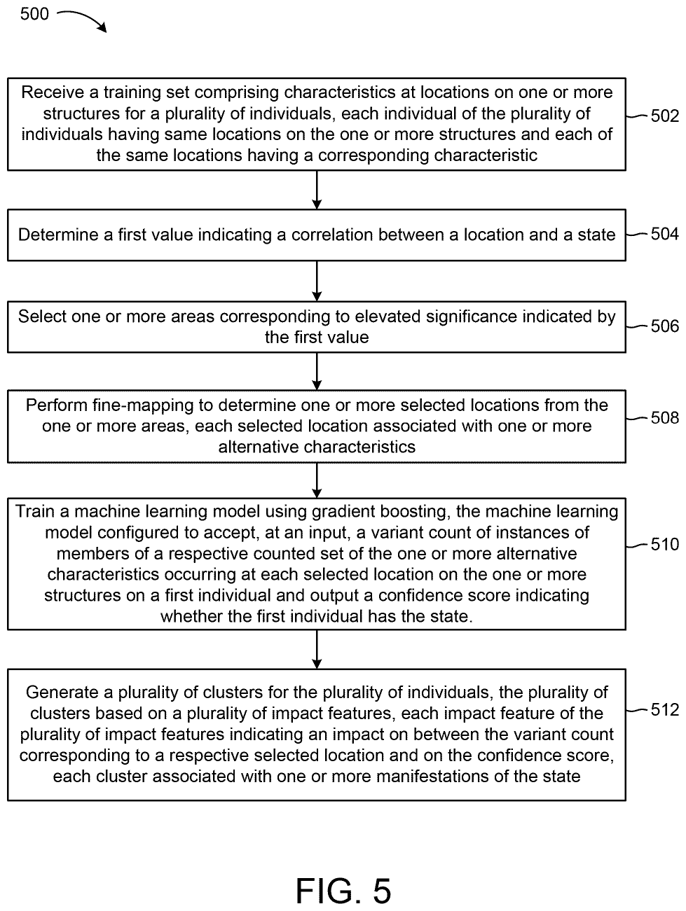

FIG. 5 shows a flow of operations 500 for generating machine learning models for low latency screening of genetic conditions according to some embodiments. In some embodiments, the flow of operations 500 also includes generating clusters for individuals having a target genetic condition based on the genetic characteristics (e.g., nucleobases and/or SNPs) contributing to the likelihood of an individual developing the target genetic condition. The flow of operations 500 may be performed by the condition evaluation system 200. For example, to perform the flow of operations 500 the condition evaluation system 200 may communicate data as indicated by the broken arrows in FIG. 2.

The flow of operations 500 may include receiving a training set comprising characteristics at locations on one or more structures for a plurality of individuals, each individual of the plurality of individuals having same locations on the one or more structures and each of the same locations having a corresponding characteristic in operation 502. Training data may be received and stored by the training data storage 242. In some embodiments, the training data comprises nucleobases at various loci on chromosomes of the individuals. The operation 502 may include filtering the training data based on parameters such as the quality of the data, the genetic conditions of the individual associated with a training sample, or other properties of the data and/or individual. The operation 502 may include initiating training, for example, by way of a user's interaction with a user interface.

In some embodiments, the flow of operations 500 includes determining a first value indicating a correlation between a location and a state in operation 504. The operation 504 may include generating a statistic to perform feature selection on the characteristics of the training set. The operation 504 may include calculating a test statistic. The test statistic may be indicative of a correlation between nucleobases at a particular locus on a chromosome and the target genetic condition. For example, the operation 504 may include calculating a binomial test statistic, a z-statistic, or statistics based on comparisons between members of each of the groups (e.g., developing or not developing the target genetic condition) such as the Mann-Whitney U-test. The operation 504 may include determining a p-value for the test statistic. The p-value may represent the probability that a test statistic meets or exceeds the value calculated for the particular locus under a null hypothesis that there is no difference in the distribution of nucleobases at the particular locus in the two groups. For example, a lower p-value (e.g., closer to zero) may indicate greater significance (e.g., more correlation, etc.) between the nucleobases at the particular locus and membership of the two groups. The p-values may be calculated by approximating the probability distribution or by referencing a stored table or function. The operation 504 may be performed by the statistic generator 212 and any of the functionality described as being performed by the statistic generator 212 may also be included in some embodiments of the operation 504.

The flow of operations 500 may include selecting one or more areas corresponding to elevated significance indicated by the first value in operation 506. The operation 506 may include comparing p-values calculated in the operation 504 to a threshold value. In some embodiments, criteria in addition to the threshold value are also used to select the areas of elevated significance. For example, the operation 504 may select areas for which a number of consecutive locations (e.g., loci) have elevated p-values or a threshold fraction of the locations within a window satisfy the threshold. In some embodiments, an area refers to multiple nearby loci on a chromosome. The operation 506 may be performed by the loci selector 214 and any of the functionality described as being performed by the loci selector 214 may also be included in some embodiments of the operation 506.

Because genetic mutations may include multiple nearby loci, the areas identified in the operation 506 may be highly correlated. Further, only some of the loci may be indicative of (e.g., have a causal relationship to) the target genetic condition. Advantageously, it is possible to reduce the number of loci for which genetic information is required by determining a locus or a few loci having a strong causal relationship. In some embodiments, the flow of operations 500 includes performing fine-mapping to determine one or more selected locations from the one or more areas, each selected location associated with one or more alternative characteristics in operation 508. Fine-mapping may refer to a process for calculating posterior probabilities that an individual location on the one or more structures (e.g., a locus on the chromosomes) and a particular characteristic (e.g., nucleobase or SNP) at the location can cause the state (e.g., target genetic condition). The operation 508 may include selecting the locus and the SNP having the greatest posterior probability. The operation 508 may include selecting multiple loci and/or SNPs having a posterior probability greater than a threshold probability from each of the areas of interest 306. The SNP for each locus selected may be added to a set of potential causal variants. Additionally, if more than one SNP at a respective locus satisfies the probability threshold, each SNP satisfying the threshold at the respective locus may be added to a set of potential causal variants. In some embodiments, a credible set comprising a minimal number of loci and/or SNPs for which at least one locus and SNP is likely (e.g., with 95% confidence) to have a causal relationship with the target genetic condition is determined in the operation 508. The operation 508 may include selecting the loci and/or SNPs from the credible set for each of the areas from the operation 508. The operation 508 may be performed by the fine-mapper 216 and any of the functionality described as being performed by the fine-mapper 216 may also be included in some embodiments of the operation 508.

The flow of operations 500 may include training a machine learning model using gradient boosting, the machine learning model configured to accept, at an input, a variant count of instances of members of a respective counted set of the one or more alternative characteristics occurring at each selected location on the one or more structures on a first individual and output a confidence score indicating whether the first individual has the state in operation 510. For example, the operation 510 may include training a machine learning model that is configured to accept a variant count representing a count of how many of the pair of chromosomes having the same locus have a nucleobase (e.g., SNP) that was identified as causal at that locus. The machine learning model may be trained using ground truth diagnoses (e.g., whether the individual of the training sample developed or did not develop the target genetic condition). For example, a ground truth label of one indicating that the individual developed the condition and a ground truth label of zero indicating that the individual did not develop the condition. By training with these ground truth values, the machine learning model may learn to output a likelihood (e.g., between zero and one) that a candidate individual will develop the target genetic condition. The operation 510 may be performed by the machine learning model trainer 222 and any of the functionality described as being performed by the machine learning model trainer 222 may also be included in some embodiments of the operation 510.

The flow of operations 500 may include generating a plurality of clusters for the plurality of individuals, the plurality of clusters based on a plurality of impact features, each impact feature of the plurality of impact features indicating an impact on between the variant count corresponding to a respective selected location and on the confidence score, each cluster associated with one or more manifestations of the state in operation 512. For example, the operation 512 may include calculating Shapely parameters or Shapely additive explanations (e.g., SHAP values). The operation 512 may include repeatedly executing the machine learning model to determine the contribution a value for a variant count at a particular locus has on the overall likelihood that a person develops the target genetic condition. The loci contributing heavily or any other pattern in the contribution to the overall likelihood may provide insight into the causes of the target genetic condition in the individuals of the training set. Clusters may be generated using feature vectors formed by the impact features for each individual of the training set. For example, the operation 512 may include performing k-means clustering, DBSCAN, OPTICS, or other suitable clustering techniques. The operation 512 may be performed by the impact analyzer 224 and the cluster generator 226, and any of the functionality described as being performed by the impact analyzer 224 and the cluster generator 226 may also be included in some embodiments of the operation 512.

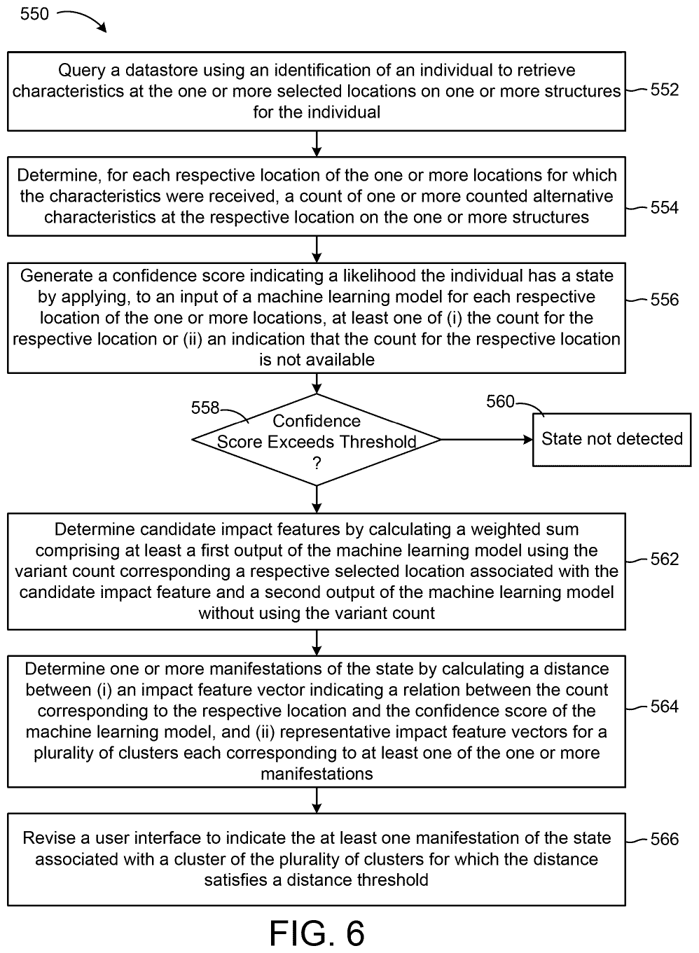

FIG. 6 shows a flow of operations 550 for determining the likelihood of a candidate individual developing a genetic condition, determining a phenotype for that individual's presentation of the genetic condition, and updating a user interface to indicate a the phenotype and/or a management plan according to some embodiments. For example, the flow of operations 550 may include using the selected loci, the trained machine learning model, and the identified clusters of impact feature vectors generated in the flow of operations 500. The flow of operations may also be performed by the condition evaluation system 200. For example, to perform the flow of operations 550 the condition evaluation system 200 may communicate data as indicated by the solid arrows in FIG. 2.

The flow of operations 550 may include querying a datastore using an identification of an individual to retrieve characteristics at the one or more selected locations on one or more structures for the individual in operation 552. For example, the operation 552 may include querying a data store for a candidate individual's genetic information including nucleobases and SNPs at the selected loci from the flow of operations 500. The operation 552 may be initiated by a user interface and include transmitting information to an API to acquire the information. For example, the operation 552 may be performed by the coordinator 210 and/or the UI generator 232.

In some embodiments, the flow of operations 550 includes determining, for each respective location of the one or more locations for which the characteristics were received, a count of one or more counted alternative characteristics at the respective location on the one or more structures in operation 554. The operation 554 may include determining a variant count. For example, the operation 554 may include counting how many of the pair of chromosomes having the same respective locus have a nucleobase (e.g., SNP) that was identified as causal at that locus. The counting procedure may be performed for each respective locus of the selected loci (e.g., locations) from the flow of operations 500. The operation 554 may be performed by the variant counter 218 and any of the functionality described as being performed by the variant counter 218 may also be included in some embodiments of the operation 554.

The flow of operations 550 may include generating a confidence score indicating a likelihood the individual has a state by applying, to an input of a machine learning model for each respective location of the one or more locations, at least one of (i) the count for the respective location or (ii) an indication that the count for the respective location is not available in operation 556. The operation 556 may include applying the counts (e.g., the variant counts) for each respective location to the inputs of the machine learning model. If the variant count is not available (e.g., because the genetic information retrieved does not include the nucleobases at the respective locus), the operation 556 may include providing the machine learning model with a NaN (not a number) or NULL value to indicate the data is missing or otherwise unavailable. In some embodiments, applying the counts to the input of the machine learning model causes the machine learning model to output the confidence score. The operation 556 may be performed by the machine learning model executor 220 and any of the functionality described as being performed by the machine learning model executor 220 may also be included in some embodiments of the operation 556.

The flow of operations 550 may include decision 558 to determine whether the confidence score exceeds a threshold value. For example, the decision 558 may include determining if the candidate individual is likely to develop the target genetic condition. If the confidence score does not exceed the threshold value (e.g., indicating a low likelihood of developing the condition), the flow of operations may end at the state (e.g., genetic condition) not being detected at operation 560. In some embodiments, the operation 560 also includes updating a user interface with the indication of the low likelihood, for example, by displaying the confidence score, etc. If the confidence score does exceed the threshold value (e.g., indicating an elevated likelihood of the candidate individual developing the condition), the flow of operations 550 may continue processing at operation 562.

In some embodiments, the flow of operations 550 includes determining candidate impact features by calculating a weighted sum comprising at least a first output of the machine learning model using the variant count corresponding to a respective selected location associated with the candidate impact feature and a second output of the machine learning model without using the variant count in the operation 562. The operation 562 may include calculating Shapley values (e.g., SHAP values). The operation 562 may include repeatedly executing the machine learning model to determine the contribution a value for a variant count at a particular locus has on the overall likelihood that a person develops the target genetic condition. For example, determining the Shapley values may include calculating a weighted sum comprising a difference between a first output of the machine learning model using the variant count for which the Shapley value is being calculated and a second output of the machine learning model without using the variant count. The weighted sum may include several such differences from the repeated execution of the machine learning model. In some embodiments, the machine learning model includes decision trees. Calculating the weighted sum may include using stored values representing the number of training samples that traverse each branch of the decision tree. The operation 562 may be performed by the impact analyzer 224 and any of the functionality described as being performed by the impact analyzer 224 may also be included in some embodiments of the operation 562.

The flow of operations 550 may include determining one or more manifestations of the state by calculating a distance between (i) an impact feature vector indicating a relation between the count corresponding to the respective location and the confidence score of the machine learning model, and (ii) representative impact feature vectors for a plurality of clusters each corresponding to at least one of the one or more manifestations in the operation 564. For example, the operation 564 may include forming an impact feature vector for the candidate individual from the impact features calculated for each variant count in operation 562. The impact feature vector for the candidate individual may be compared to the clusters generated during training (e.g., by the flow of operations 500) in the operation 564. Comparing the impact feature vector to a cluster may include calculating a distance metric between the impact feature vector and the clusters. For example, a distance metric may be determined using a p-norm (e.g., 1-norm, 2-norm, etc.) in the space of the impact feature vector or in a lower-dimensional space (e.g., after performing PCA or UMAP). In some embodiments, the distance metric is calculated between the impact feature vector and a representative vector for each cluster (e.g., the mean, mode, etc. of the cluster). In some embodiments, a distance is calculated for multiple representative vectors or all the vectors from the training data for a cluster, and the distance metric is an average, median, percentile, etc. of the distance between the multiple impact feature vectors and the multiple representative vectors or the vectors from the training data that are members of the cluster. The operation 564 may be performed by the cluster selector 228 and any of the functionality described as being performed by the cluster selector 228 may also be included in some embodiments of the operation 564.

The operation 564 may include selecting the cluster having the minimum distance and retrieving a manifestation (e.g., presentation, phenotype, etc.) of the condition based on the selected cluster. For example, each cluster may be associated with one or more manifestations and/or management plan during training. The operation 564 may select an appropriate cluster and thereby may determine the one or more manifestations of the condition for the candidate individual and/or a management plan including therapies, restrictions, etc. that can improve the outcome for the candidate individual.

In some embodiments, the flow of operations 550 includes revising a user interface to indicate the at least one manifestation of the state associated with a cluster of the plurality of clusters for which the distance satisfies a distance threshold in operation 566. For example, the UI generator 232 may generate instructions for one or more client devices 140 that display the candidate individual's phenotype with respect to the target genetic condition. Other functionality described as performed by the UI generator 232 may also be included in the operation 566. For example, the operation 566 may include updating the user interface with the confidence score (e.g., the disorder likelihood) the impact feature vector within the two or three-dimensional cluster plot from the training data, a management plan for the phenotype, etc.

### Example Embodiments

The low-latency screening system 100 and/or the condition evaluation system 200 have several applications within for detection of genetic conditions of an individual. The example embodiments described herein are exemplary and not intended to be limiting in any way.

Some embodiments relate to a system for low latency state detection using gradient boosting. The system includes one or more processors configured by computer-readable instructions to receive a training set comprising characteristics at locations on one or more structures for a plurality of individuals, each individual of the plurality of individuals having same locations on the one or more structures and each of the same locations having a corresponding characteristic. The one or more processors are also configured to determine a first value indicating a correlation between a location and a state. The one or more processors are also configured to select, based on the first value, one or more selected locations, each selected location associated with one or more alternative characteristics. The one or more processors are also configured to train a machine learning model using gradient boosting, the machine learning model configured to (i) accept, at an input, a variant count of instances of members of a respective counted set of the one or more alternative characteristics occurring at each selected location on the one or more structures on a first individual and (ii) output a confidence score indicating whether the first individual has the state. The one or more processors are also configured to generate a plurality of clusters for the plurality of individuals based on a plurality of impact features, each impact feature of the plurality of impact features indicating an impact on the variant count corresponding to a respective selected location on the confidence score, each cluster associated with one or more manifestations of the state. The one or more processors are also configured to receive, from a user interface presented at a client device, an identification of a candidate individual. The one or more processors are also configured to query a datastore using the identification to retrieve characteristics at the one or more selected locations on the one or more structures for the candidate individual execute the machine learning model to generate a candidate confidence score indicating whether the candidate individual has the state; and responsive to the candidate confidence score exceeding a threshold (i) repeatedly execute the machine learning model to determine candidate impact features for the candidate individual and (ii) determine a cluster of the plurality of clusters for the candidate individual based on a distance between the candidate impact features for the candidate individual and the plurality of clusters. The one or more processors are also configured to revise the user interface at the client device to indicate the one or more manifestations of the state associated with the cluster for the candidate individual.

In some embodiments, state detection refers to detecting a genetic condition within an individual (e.g., genetic screening, etc.). For example, a state may represent the state of having or being susceptible to a genetic condition. In some embodiments, the characteristics at locations refer to the nucleobases or SNPs at one or more loci on a chromosome. In some embodiments, the counted set of alternative characteristics refer to the SNPs that are correlated with the genetic condition. In some embodiments, structures of an individual may refer to an individual's chromosomes. Chromosomes come in pairs having the same loci, but potentially having different SNPs at the loci. The variant count input to the machine learning model may refer to a count indicating whether the SNP occurs on zero, one, or two of the chromosome pairs. In some embodiments, manifestations of the state refer to phenotypes for the genetic condition.

For example, some embodiments relate to a system for low latency genetic screening using gradient boosting. The system includes one or more processors configured by computer-readable instructions to receive a training set comprising nucleobases at loci of one or more chromosomes of an individual, the training set of genetic information of each individual of the plurality of individuals having same loci on the one or more chromosomes and each of the same loci having a corresponding nucleobase. The one or more processors are also configured to determine a first value indicating a correlation between a locus on the one or more chromosomes and a target genetic condition (e.g., disorder, disease, etc.). The one or more processors are also configured to select, based on the first value, one or more selected loci, each selected loci associated with one or more SNPs. The one or more processors are also configured to train a machine learning model using gradient boosting, the machine learning model configured to (i) accept, at an input, a variant count indicating a number of chromosomes on which members of a set of variants occurring at each selected loci for a first individual and (ii) output a confidence score indicating whether the first individual has the target genetic condition. The one or more processors are also configured to generate a plurality of clusters for the plurality of individuals based on a plurality of impact features, each impact feature of the plurality of impact features indicating an impact on the variant count corresponding to a respective selected locus on the confidence score, each cluster associated with one or more phenotypes for the target genetic condition. The one or more processors are also configured to receive, from a user interface presented at a client device, an identification of a candidate individual. The one or more processors are also configured to query a datastore using the identification to retrieve genetic information comprising the nucleobases at the one or more selected loci on the one or more chromosomes for the candidate individual and execute the machine learning model to generate a candidate confidence score indicating whether the candidate individual has the target genetic condition; and responsive to the candidate confidence score exceeding a threshold (i) repeatedly execute the machine learning model to determine candidate impact features for the candidate individual and (ii) determine a cluster of the plurality of clusters for the candidate individual based on a distance between the candidate impact features for the candidate individual and the plurality of clusters. The one or more processors are also configured to revise the user interface at the client device to indicate the one or more phenotypes of the state associated with the cluster for the candidate individual.

In some embodiments, the one or more processors are configured to determine the first value by generating a p-value of a test statistic.

In some embodiments, the one or more processors are configured to determine the first value for each of the locations, and wherein the first value for the one or more selected locations satisfies a selection threshold. For example, in some embodiments, the one or more processors are configured to determine the first value for each of the loci, and wherein the first value for the one or more selected loci satisfies a selection threshold.

In some embodiments, the one or more processors are configured to select the one or more selected locations by determining, from clusters of locations that satisfy the selection threshold, a selected location at which an alternative characteristic is indicative of a causal relationship to the state. For example, in some embodiments, the one or more processors are configured to select the one or more selected loci by determining, from clusters of loci that satisfy the selection threshold, a selected locus at which an SNP indicates a causal relationship to the target genetic condition.

In some embodiments, gradient boosting comprises a categorical boosting algorithm.

In some embodiments, the categorical boosting algorithm is CatBoost.

In some embodiments, the one or more processors are configured to train the machine learning model by inputting, to the machine learning model, an indication that the corresponding characteristic is missing from a location of the one or more selected locations. For example, in some embodiments, the one or more processors are configured to train the machine learning model by inputting, to the machine learning model, an indication that the nucleobase or SNP is missing in a training sample from the training set at a locus of the one or more selected loci.

In some embodiments, the one or more processors are configured to determine a candidate impact feature of the candidate impact features by calculating a weighted sum comprising at least a first output of the machine learning model using the variant count corresponding the respective selected location (e.g., locus) associated with the candidate impact feature and a second output of the machine learning model without using the variant count.

In some embodiments, the one or more manifestations include at least one of an age of onset of the state, a severity of the state, or a susceptibility to a second state caused by the state. For example, in some embodiments, the one or more phenotypes include at least one of an age of onset of the target genetic condition, a severity of the target genetic condition, or a susceptibility to a second condition (e.g., disorder, disease, etc.) caused by the target genetic condition.

In some embodiments, the one or more processors are configured to revise the user interface at the client device to indicate a management plan for the state. For example, in some embodiments, the one or more processors are configured to revise the user interface at the client device to indicate a management plan for the target genetic condition.

Some embodiments relate to a system for low latency state detection using gradient boosting, the system includes one or more processors configured by computer-readable instructions to query a datastore using an identification of an individual to retrieve characteristics at one or more locations on one or more structures for the individual. The one or more processors are also configured to determine, for each respective location of the one or more locations for which the characteristics were received, a count of one or more counted alternative characteristics at the respective location on the one or more structures. The one or more processors are also configured to generate a confidence score indicating a likelihood the individual has a state by applying, to an input of a machine learning model for each respective location of the one or more locations, at least one of (i) the count for the respective location or (ii) an indication that the count for the respective location is not available. The one or more processors are also configured to, responsive to the confidence score exceeding a threshold, determine one or more manifestations of the state by calculating a distance between (i) an impact feature vector indicating a relation between the count corresponding to the respective location and the confidence score of the machine learning model, and (ii) representative impact feature vectors for a plurality of clusters each corresponding to at least one of the one or more manifestations and revise a user interface to indicate the at least one manifestation of the state associated with a cluster of the plurality of clusters for which the distance satisfies a distance threshold.

For example, some embodiments relate to a system for low latency genetic screening using gradient boosting, the system includes one or more processors configured by computer-readable instructions to query a datastore using an identification of an individual to retrieve genetic information including nucleobases at one or more loci on one or more chromosomes for the individual. The one or more processors are also configured to determine, for each respective locus of the one or more loci for which the nucleobases were received, a variant count indicating a number of chromosomes having a SNP. The one or more processors are also configured to generate a confidence score indicating a likelihood the individual has a target genetic condition (e.g., disorder, disease, etc.) by applying, to an input of a machine learning model for each respective location of the one or more locations, at least one of (i) the variant count for the respective locus or (ii) an indication that the variant count for the respective locus is not available. The one or more processors are also configured to, responsive to the confidence score exceeding a threshold, determine one or more phenotypes for the target genetic condition by calculating a distance between (i) an impact feature vector indicating a relation between the count corresponding to the respective location and the confidence score of the machine learning model, and (ii) representative impact feature vectors for a plurality of clusters each corresponding to at least one of the one or more phenotypes and revise a user interface to indicate the at least one phenotypes associated with a cluster of the plurality of clusters for which the distance satisfies a distance threshold.

In some embodiments, the machine learning model comprises a categorical gradient boosting architecture.

In some embodiments, the impact feature vector comprises shapely additive explanation (SHAP) values for the location. For example, in some embodiments, the impact feature vector comprises shapely additive explanation (SHAP) values for the locus.

In some embodiments, the one or more manifestations comprise at least one of an age of onset of the state, a severity of the state, or a susceptibility to a second state caused by the state. For example, in some embodiments, the one or more manifestations comprise at least one of an age of onset of the target genetic condition, a severity of the target genetic condition, or a susceptibility to a second condition (e.g., disorder, disease, etc.) caused by the target genetic condition.

In some embodiments, the one or more processors are configured to revise the user interface to indicate a management plan for the state. For example, in some embodiments, the one or more processors are configured to revise the user interface to indicate a management plan for the target genetic condition and/or a phenotype of the target genetic condition.

Some embodiments relate to a method for low latency detection of a state using gradient boosting, the method includes receiving, by one or more processors, a training set comprising characteristics at locations on one or more structures for a plurality of individuals, each individual of the plurality of individuals having same locations on the one or more structures and each of the same locations having a corresponding characteristic. The method also includes training, by the one or more processors, a machine learning model using gradient boosting, the machine learning model configured to accept, at an input, a variant count of instances of members of a respective counted set of one or more alternative characteristics occurring at each of selected locations on the one or more structures on a first individual and output a confidence score indicating whether the first individual has the state. The method also includes generating, by the one or more processors, a plurality of clusters for the plurality of individuals based on a plurality of impact features, each impact feature of the plurality of impact features indicating an impact on a variant count corresponding to a respective selected location on the confidence score, each cluster associated with one or more manifestations of the state. The method also includes receiving, by the one or more processors, from a user interface presented at a client device, an identification of a candidate individual. The method also includes querying, by the one or more processors, a datastore using the identification to retrieve the characteristics at the one or more selected locations on the one or more structures for a candidate individual. The method also includes executing, by the one or more processors, the machine learning model to generate the confidence score indicating whether the candidate individual has the state. The method also includes, responsive to the confidence score exceeding a threshold executing, by the one or more processors, the machine learning model repeatedly to determine candidate impact features for the candidate individual, determining, by the one or more processors, a cluster of the plurality of clusters for the candidate individual based on a distance between the candidate impact features for the candidate individual and the plurality of clusters, and revising, by the one or more processors, the user interface at the client device to indicate the one or more manifestations of the state associated with the cluster for the candidate individual.

For example, some embodiments relate to a method for low latency genetic screening using gradient boosting, the method includes receiving, by one or more processors, a training set of genetic information comprising nucleobases at loci on one or more chromosomes for a plurality of individuals, each individual of the plurality of individuals having same loci on the one or more chromosomes and each of the same loci having a corresponding nucleobase. The method also includes training, by the one or more processors, a machine learning model using gradient boosting, the machine learning model configured to accept, at an input, a variant count indicating a number of chromosomes on which members of a set of variants occurring at each selected loci for a first individual and output a confidence score indicating whether the first individual has a target genetic condition. The method also includes generating, by the one or more processors, a plurality of clusters for the plurality of individuals based on a plurality of impact features, each impact feature of the plurality of impact features indicating an impact on a variant count corresponding to a respective selected locus on the confidence score, each cluster associated with one or more phenotypes for the target genetic condition. The method also includes receiving, by the one or more processors, from a user interface presented at a client device, an identification of a candidate individual. The method also includes querying, by the one or more processors, a datastore using the identification to retrieve the genetic information including nucleobases at the one or more selected loci on the one or more chromosomes for a candidate individual. The method also includes executing, by the one or more processors, the machine learning model to generate the confidence score indicating whether the candidate individual has the target genetic condition. The method also includes, responsive to the confidence score exceeding a threshold executing, by the one or more processors, the machine learning model repeatedly to determine candidate impact features for the candidate individual, determining, by the one or more processors, a cluster of the plurality of clusters for the candidate individual based on a distance between the candidate impact features for the candidate individual and the plurality of clusters, and revising, by the one or more processors, the user interface at the client device to indicate the one or more phenotypes for the state associated with the cluster for the candidate individual.

In some embodiment, the method also includes revising the user interface at the client device to indicate a management plan for the state. For example, in some embodiments, the method also includes revising the user interface at the client device to indicate a management plan for the target genetic condition and/or the person's phenotype.

In some embodiments, gradient boosting includes a categorical boosting algorithm.

In some embodiments, training the machine learning model includes inputting, to the machine learning model, an indication that the corresponding characteristic is missing from a location of the one or more selected locations. For example, in some embodiments, training the machine learning model includes inputting, to the machine learning model, an indication that the corresponding nucleobase or SNP for a locus of the one or more selected loci is unavailable.

In some embodiments, determining the candidate impact features comprises calculating, for each candidate impact feature of the candidate impact features, a weighted sum comprising at least a first output of the machine learning model using the variant count corresponding the respective selected location associated with the candidate impact feature and a second output of the machine learning model without using the variant count. For example, in some embodiments, determining the candidate impact features comprises calculating, for each candidate impact feature of the candidate impact features, a weighted sum comprising at least a first output of the machine learning model using the variant count corresponding the respective selected locus associated with the candidate impact feature and a second output of the machine learning model without using the variant count.

Instructions, modules, portions of memory, etc. described as configured to perform a function (or described as performing the function) may include embodiments for which the module is configured to cause the performance of the function (or is causing the performance of the function). Similarly, instructions, modules, portions of memory, etc. described as configured to cause the performance of a function (or described as causing the performance of a function) may include embodiments for which the module is configured to perform the function (or is performing the function).

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all the described terms. References to at least one of a conjunctive list of terms may be construed as an inclusive OR to indicate any of a single, more than one, and all the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting the described systems and methods. The scope of the systems and methods described herein is thus indicated by the appended claims, rather than the foregoing description, and changes that come within the meaning and range of equivalency of the claims are embraced therein.

What is claimed is:

1. A system for low latency state detection using gradient boosting, the system comprising one or more processors configured by computer-readable instructions to:
receive a training set comprising characteristics at locations on one or more structures for a plurality of individuals, each individual of the plurality of individuals having same locations on the one or more structures and each of the same locations having a corresponding characteristic;
determine a first value indicating a correlation between a location and a state;
select, based on the first value, one or more selected locations, each selected location associated with one or more alternative characteristics;
train a machine learning model using gradient boosting, the machine learning model configured to:
accept, at an input, a variant count of instances of members of a respective counted set of the one or more alternative characteristics occurring at each selected location on the one or more structures on a first individual; and
output a confidence score indicating whether the first individual has the state;
generate a plurality of clusters for the plurality of individuals based on a plurality of impact features, each impact feature of the plurality of impact features indicating an impact on the variant count corresponding to a respective selected location on the confidence score, each cluster associated with one or more manifestations of the state;
receive, from a user interface presented at a client device, an identification of a candidate individual;
query a datastore using the identification to retrieve characteristics at the one or more selected locations on the one or more structures for the candidate individual;
execute the machine learning model to generate a candidate confidence score indicating whether the candidate individual has the state; and
responsive to the candidate confidence score exceeding a threshold:
repeatedly execute the machine learning model to determine candidate impact features for the candidate individual;
determine a cluster of the plurality of clusters for the candidate individual based on a distance between the candidate impact features for the candidate individual and the plurality of clusters; and
revise the user interface at the client device to indicate the one or more manifestations of the state associated with the cluster for the candidate individual.

2. The system of claim 1, wherein the one or more processors are configured to determine the first value by generating a p-value of a test statistic.

3. The system of claim 1, wherein the one or more processors are configured to determine the first value for each of the locations, and wherein the first value for the one or more selected locations satisfies a selection threshold.

4. The system of claim 3, wherein the one or more processors are configured to select the one or more selected locations by:
determining, from clusters of locations that satisfy the selection threshold, a selected location at which an alternative characteristic is indicative of a causal relationship to the state.

5. The system of claim 1, wherein gradient boosting comprises a categorical boosting algorithm.

6. The system of claim 5, wherein the categorical boosting algorithm is CatBoost.

7. The system of claim 1, wherein the one or more processors are configured to train the machine learning model by inputting, to the machine learning model, an indication that the corresponding characteristic is missing from a location of the one or more selected locations.

8. The system of claim 1, wherein the one or more processors are configured to determine a candidate impact feature of the candidate impact features by calculating a weighted sum comprising at least a first output of the machine learning model using the variant count corresponding the respective selected location associated with the candidate impact feature and a second output of the machine learning model without using the variant count.

9. The system of claim 1, wherein the one or more manifestations comprise at least one of:
an age of onset of the state;
a severity of the state; or
a susceptibility to a second state caused by the state.

10. The system of claim 1, wherein the one or more processors are configured to revise the user interface at the client device to indicate a management plan for the state.

11. A system for low latency state detection using gradient boosting, the system comprising one or more processors configured by computer-readable instructions to:
query a datastore using an identification of an individual to retrieve characteristics at one or more locations on one or more structures for the individual;
determine, for each respective location of the one or more locations for which the characteristics were received, a count of one or more counted alternative characteristics at the respective location on the one or more structures;
generate a confidence score indicating a likelihood the individual has a state by applying, to an input of a machine learning model for each respective location of the one or more locations, at least one of (i) the count for the respective location or (ii) an indication that the count for the respective location is not available; and
responsive to the confidence score exceeding a threshold:
determine one or more manifestations of the state by calculating a distance between (i) an impact feature vector indicating a relation between the count corresponding to the respective location and the confidence score of the machine learning model, and (ii) representative impact feature vectors for a plurality of clusters each corresponding to at least one of the one or more manifestations; and
revise a user interface to indicate the at least one manifestation of the state associated with a cluster of the plurality of clusters for which the distance satisfies a distance threshold.

12. The system of claim 11, wherein the machine learning model comprises a categorical gradient boosting architecture.

13. The system of claim 11, wherein the impact feature vector comprises shapely additive explanation (SHAP) values for the location.

14. The system of claim 11, wherein the one or more manifestations comprise at least one of:
an age of onset of the state;
a severity of the state; or
a susceptibility to a second state caused by the state.

15. The system of claim 11, wherein the one or more processors are configured to revise the user interface to indicate a management plan for the state.

16. A method for low latency detection of a state using gradient boosting, the method comprising:
receiving, by one or more processors, a training set comprising characteristics at locations on one or more structures for a plurality of individuals, each individual of the plurality of individuals having same locations on the one or more structures and each of the same locations having a corresponding characteristic;
training, by the one or more processors, a machine learning model using gradient boosting, the machine learning model configured to:
accept, at an input, a variant count of instances of members of a respective counted set of one or more alternative characteristics occurring at each of selected locations on the one or more structures on a first individual; and
output a confidence score indicating whether the first individual has the state;
generating, by the one or more processors, a plurality of clusters for the plurality of individuals based on a plurality of impact features, each impact feature of the plurality of impact features indicating an impact on a variant count corresponding to a respective selected location on the confidence score, each cluster associated with one or more manifestations of the state;
receiving, by the one or more processors, from a user interface presented at a client device, an identification of a candidate individual;
querying, by the one or more processors, a datastore using the identification to retrieve the characteristics at the one or more selected locations on the one or more structures for a candidate individual;
executing, by the one or more processors, the machine learning model to generate the confidence score indicating whether the candidate individual has the state; and
responsive to the confidence score exceeding a threshold:
executing, by the one or more processors, the machine learning model repeatedly to determine candidate impact features for the candidate individual;
determining, by the one or more processors, a cluster of the plurality of clusters for the candidate individual based on a distance between the candidate impact features for the candidate individual and the plurality of clusters; and
revising, by the one or more processors, the user interface at the client device to indicate the one or more manifestations of the state associated with the cluster for the candidate individual.

17. The method of claim 16, further comprising revising the user interface at the client device to indicate a management plan for the state.

18. The method of claim 16, wherein gradient boosting comprises a categorical boosting algorithm.

19. The method of claim 16, wherein training the machine learning model comprises inputting, to the machine learning model, an indication that the corresponding characteristic is missing from a location of the one or more selected locations.

20. The method of claim 16, wherein determining the candidate impact features comprises calculating, for each candidate impact feature of the candidate impact features, a weighted sum comprising at least a first output of the machine learning model using the variant count corresponding the respective selected location associated with the candidate impact feature and a second output of the machine learning model without using the variant count.
